(19) United States
(12) Patent Application Publication
(10) Pub. No.: US 2007/0288661 A1
(43) Pub. Date: Dec. 13, 2007

(54) Method and media for reducing executable storage requirements in wireless environment

(75) Inventors: Michel Guillemot, Paris (FR); Alexandre Pelletier-Normand, Montreal (CA); Charles Donohue, Montreal (CA); Dominique Canzeri, Montreal (CA)

Correspondence Address: BLAKELY SOKOLOFF TAYLOR & ZAFMAN, 1279 OAKMEAD PARKWAY, SUNNYVALE, CA, 94085-4040, US

(73) Assignee: Gameloft, S.A.

(21) Appl. No.: 11/440,483

(22) Filed: May 24, 2006

(51) Int. Cl. G06F 15/16

(52) U.S. Cl. 709/247

(57) ABSTRACT

A system including compressed executable codes copies and decompresses the executable codes into a volatile memory buffer, then executes the codes. Modules containing compressed executable codes may be downloaded from a server via a wireless connection. Software development environments to prepare compressed executable modules are also described.

### FIELD

The invention relates to programmable wireless computing environments. In particular, the invention relates to techniques to provide added functionality to wireless computing devices without requiring additional system resources.

### BACKGROUND

Mobile computing systems such as personal digital assistants (“PDAs”) and cellular telephones are often highly integrated devices that give up expandability for smaller size and reduced power consumption. For example, a mobile system might lack an expansion connector to add additional memory: the connector might occupy valuable circuit board space and an expanded memory might require the use of a larger battery. Thus, providing the mere possibility of expansion may cause undesirable effects in the product (larger size, larger battery) even though the additional memory might never be added. Nevertheless, users often demand more functionality even in a system whose basic hardware configuration is fixed. Techniques to make more efficient use of available hardware resources may be of value in this field.

### SUMMARY

Embodiments of the invention compress modules to implement various functions before storing them in a system that may have limited resources. Compression may leave more resources available for other data, and may thus permit a larger number of functions and/or resources such as graphical or audio assets to be stored. When a function implemented by a compressed module is invoked, the module is retrieved and decompressed, then executed to provide the requested function.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows features of a mobile computing system.

FIG. 2 shows a sample executable module including its header.

FIG. 3 is a flowchart of operations according to an embodiment of the invention.

FIG. 4 is a second flowchart of operations in a specific execution environment.

FIG. 5 shows an executable application as a monolithic object containing a plurality of compressed modules according to an embodiment of the invention.

### DETAILED DESCRIPTION

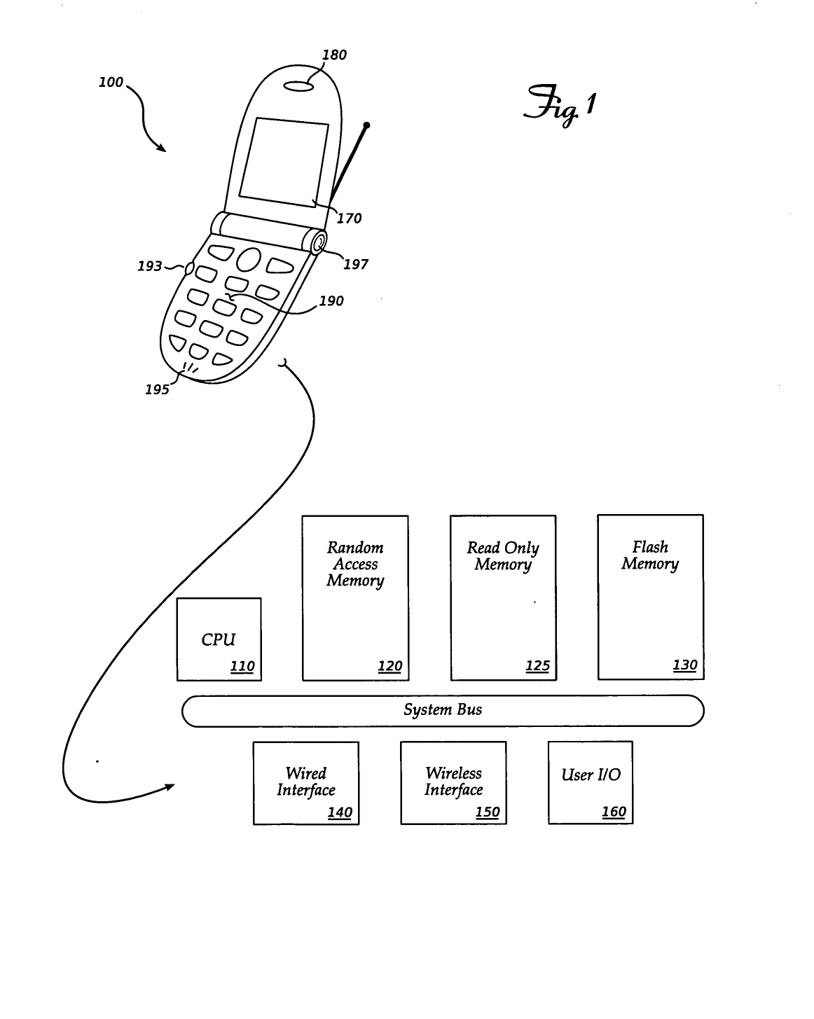

FIG. 1 shows a number of subsystems that may be present in a mobile computing system 100 that implements an embodiment of the invention. Central processing unit (“CPU”) 110 (also known as a “processor”or “microprocessor”) is a programmable logic device that can execute instructions contained in a memory 120. As shown here, several different memories, each of which may have a different functional profile, may be provided. For example, memory 120 may be a standard volatile random access memory (“RAM”) that provides relatively fast access to its contents and consumes a moderate amount of power. Read-only memory (“ROM”) 125 may have slower access, but may consume less power, and (unlike RAM 120) may preserve its contents even when power is unavailable. Flash memory 130 may combine the non-volatility of ROM 125 with the writeability of RAM 120, but may require additional power to operate. Some systems may further subdivide one or more of the available memories into regions dedicated to holding a certain kind of data.

Most mobile systems have some facility for communicating with peer systems. The system shown in this figure includes a wired interface 140 and a wireless interface 150. A wireless interface may permit data transfer over radio or free-air optical signals, while a wired interface may permit data exchange over a physical wire or fiber optic cable. Embodiments of the invention can work with any sort of communication facility, but may be particularly useful in systems, such as cellular telephones, that communicate wirelessly via a radio link to a cellular telephone repeater or tower.

A mobile system designed for human interaction will include one or more user input and output (“I/O”) devices 160. Several possible I/O devices are identified in perspective view 100: display 170 presents visual information to the user and speaker 180 presents audio information. Input facilities 100-197 accept commands and data from the user. The system shown here has a keypad 190, scroll wheel 193, microphone 195 and camera 197.

Software instructions stored in one of the memories of this system can control and coordinate the interactions of various subsystems to fulfill a user's needs. For example, a simple program could establish a connection to a telephone via the wireless interface, then transmit sounds from microphone 195 to the telephone, and play sounds from the telephone on speaker 180. Other software may be provided to capture an image with camera 197 or to play music data stored in a memory. Some software functions may be considered basic or essential to the proper operation of the device, while others may be selected according to the user's individual needs or taste. For example, some users may wish to use the device to download information from a distributed data network such as the Internet. Other users may wish to play games. Auxiliary functions to interact with the Internet or to play games may be loaded into the memory of the device if sufficient space is available, and invoked at the user's convenience.

As is known to software engineers and others of skill in the relevant arts, software functions are usually separated into distinct entities called “programs” or “applications.” A computing system, such as the mobile system shown in FIG. 1, may have a basic set of software known as an operating system (“OS”) whose function is to load and unload programs when needed, to allocate processing, memory and other resources among the programs, and often to manage the low-level functioning of the system and its hardware. Other programs may be launched at the user's direction or in response to conditions or events detected by the OS or by a program that is already running.

Programs include instructions to cause the mobile system's processor(s) to operate in a particular way, and may also include data necessary to complete the intended function. Instructions may be bit or byte sequences that directly control the processor (“machine instructions”) or bytecodes that are processed by an interpreter to cause the desired operation. Machine instructions may be limited to execution on a particular model of CPU, while bytecodes may be executed by any system for which an interpreter exists. The Java™ language according to a specification by Sun Microsystems, Inc. of Santa Clara, Calif., is a well-known example of a language where bytecodes control an interpreter to execute a program.

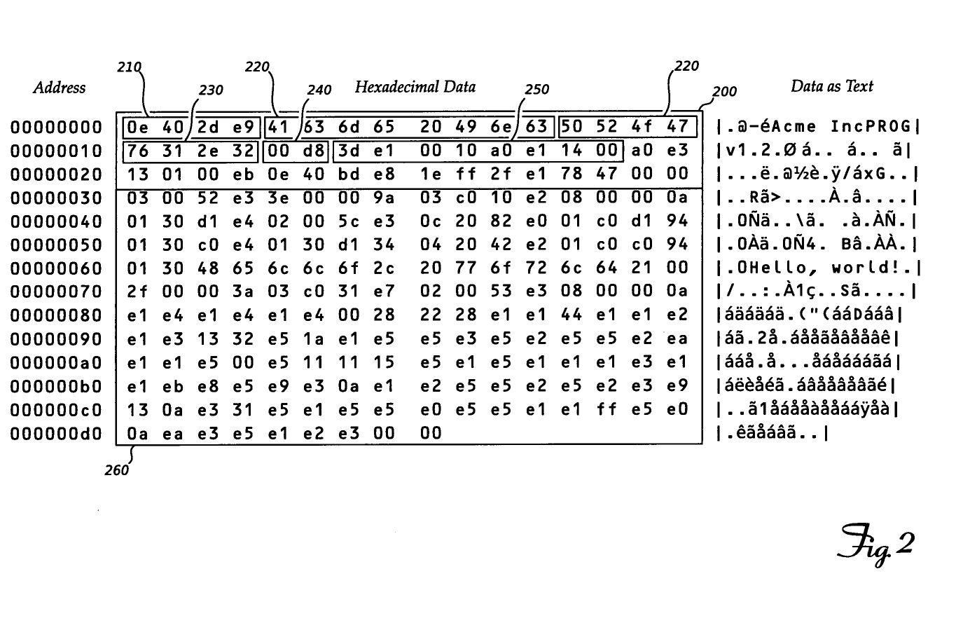

Programs to be loaded and executed on a mobile system by the OS may be required to conform to a standard structure or to provide certain information at fixed locations. FIG. 2 shows an array of bytes that forms an executable module for a hypothetical system. The array includes an “executable header” 200, which is a data structure that describes a sequence of bytes that can be loaded and executed by a mobile system. The executable header is segregated into a number of fields, each containing a number of bits of data. Field 210 contains a special value called a “magic number,” which indicates that the remainder of the data conforms to a particular structure. (Random or damaged data would be less likely to have the correct magic number at the beginning.) Fields for a developer identification (220), application identification (230) and version (230) may be useful. Field 240 contains the length of the complete module, and field 250 contains a cryptographic hash of the module. The data shown in area 260, after the executable header, is the data and instructions (or bytecodes) of the application.

Computing systems and mobile devices vary in the structure they expect of executable modules. Some may require more information in the executable header, while others may require little or none. However, most executable module formats will include at least enough information to permit the system to determine whether the module could be a valid program for the platform. For example, a format that includes a magic number and a cryptographic hash or other checksum at known offsets within the array of bytes can provide protection against accidentally attempting to execute a corrupted module or a non-executable data file.

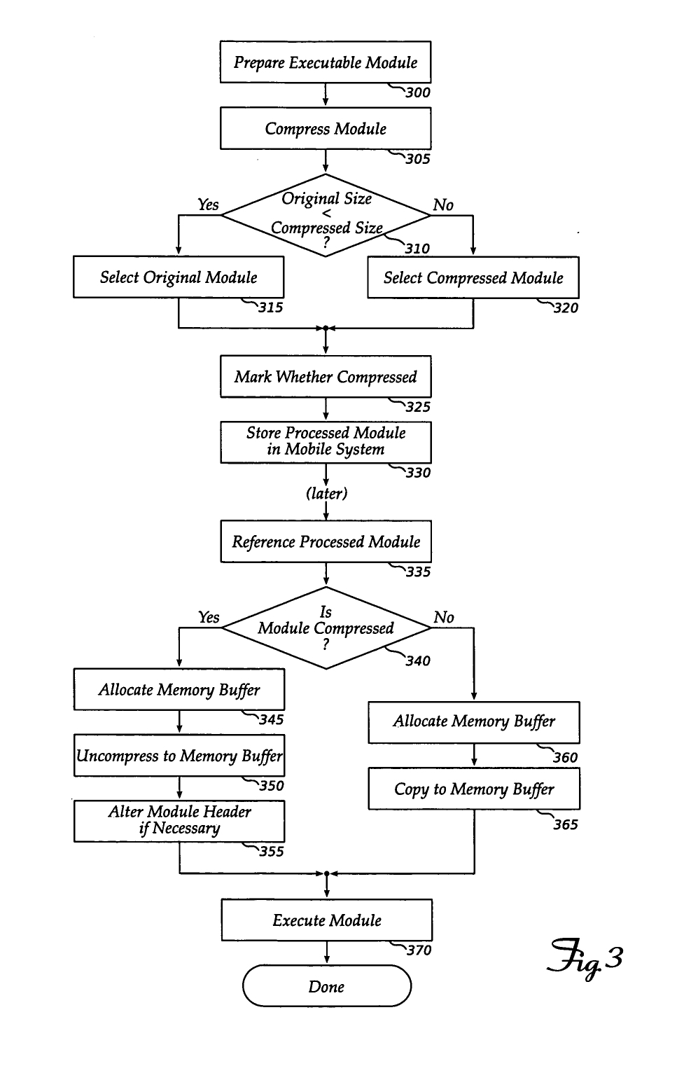

The executable module depicted in FIG. 2 may occupy space in a memory of a system even when it is not being executed. However, since memory (and storage space generally) may be a limited resource, a system implementing an embodiment of the invention may be able to conserve memory by operating as outlined and explained with reference to FIG. 3. First, the executable module is prepared according to conventional software development practices (300). These may include designing and implementing the program in a high-level language such as C, C++ or Java™; compiling the program to produce machine instructions or interpreter bytecodes; linking the program with libraries containing standard functions; testing and debugging the program (perhaps on a simulated system); and so forth. Eventually, an executable module in the proper format for the target system is constructed. This module may be a byte array that is at least conceptually like the array shown in FIG. 2.

Next, the module is compressed using one of many data compression algorithms known in the art (305). The Lempel-Ziv-Welch (“LZW”) compression algorithm described in U.S. Pat. No. 4,558,302 to Welch is one such algorithm. A favored embodiment of the invention uses the Lempel-Ziv Markov-chain (“LZMA”) compression algorithm. A key requirement of the algorithm is that it must be lossless—that is, when the compressed module is decompressed, it must be bit-for-bit identical to the original module. Thus, “lossy” compression formats such as the Joint Photographic Experts Group (“JPEG”) format cannot normally be used.

Sometimes compressing a block of data actually increases its size. This is uncommon, but an embodiment of the invention may achieve improved performance by comparing the original and compressed modules'sizes (310) and selecting the smaller of the two (315, 320). If a module is not certain to be compressed, it should be marked with a flag or other indicator to show whether it is or is not compressed (325).

Note that compressing an executable module is likely to transform the module from a correctly-formatted module with proper magic numbers, checksums and other features, into a smaller array that is not correctly formatted. This fact can be used as an implicit compression indicator: if a module is not a correctly-formatted executable module, but when decompressed, is a correctly-formatted module, then no separate compression indicator is necessary. Another option for indicating a compressed module without an explicit flag is to associate the module with a predetermined name. For example, if ordinary (uncompressed) executable modules are given names ending in the string “.mod”, then a compressed module could be identified by a different suffix such as “.mzd”.

Finally, in the first phase of operations according to an embodiment of the invention, the processed executable module is stored in the mobile system (330). It may be stored in a non-volatile memory such as a Flash memory, an electrically-eraseable, programmable, read-only memory (“EEPROM”), on an electromechanical storage device such as a hard disk, or in a volatile memory such as RAM.

Later, when a function implemented by the processed executable module is invoked (either by the user or automatically in response to some stimulus), operations continue as follows. A module loader references the processed executable module (335) and determines (via the flag, indicator, implicit mechanism, or other similar means) whether the module is compressed (340). If it is, a memory buffer large enough to contain the decompressed module is allocated (345) and the compressed module is decompressed and copied to the memory buffer (350). The decompressed module may require some alterations so that its header contents agree with its position in the allocated memory buffer. For example, some executable headers contain an address of an entry point or other memory-address-specific information. Therefore, after decompressing the module, the module header is modified if necessary (355). If the processed module was not compressed, it may be copied to a similarly-allocated buffer (360, 365) or simply executed in place. (Operations 360 and 365 may simply be in accordance with the ordinary functioning of the computing system.)

Finally, the module loader causes a programmable processor to begin executing machine instructions or bytecodes in the executable module (370).

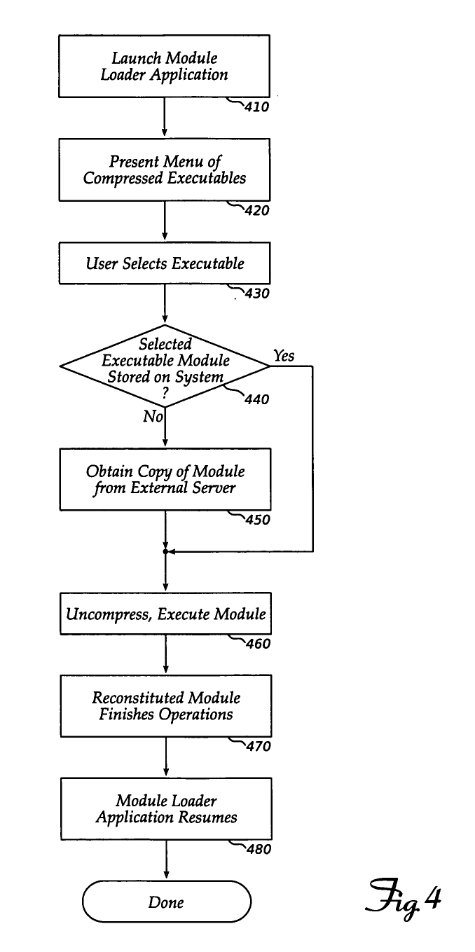

The module loader mentioned in the description of FIG. 3 may be a part of the mobile platform's operating system (“OS”) or it may be a separate program. The OS will have a mechanism to locate and execute applications as required, and in some embodiments, that mechanism is extended to check for and process compressed executable modules. In other environments, the OS may be fixed or unalterable, and may lack decompression functionality. In the latter type of system, the OS may simply reject a compressed module as invalid (recall that a compressed module is unlikely to have correct values in various header fields). To enable resource conservation in this type of system, an ordinary program that can be started by the OS can serve as a module loader. Details of this process are explained with reference to FIG. 4, which describes the operation of an embodiment of the invention on a mobile platform that implements the Binary Runtime Environment for Wireless (“BREW”). (Binary Runtime Environment for Wireless and the acronym BREW are trademarks of their creator, Qualcomm Incorporated of San Diego, Calif.)

First, the user of the system causes the system to launch (i.e. begin to execute) a module loader application (410). This application is an ordinary, non-compressed program. It may contain one or more compressed executable modules within its own byte array as data objects, or may be able to locate compressed executable modules in a memory or storage device of the system. In some embodiments, the module loader may be able to download compressed executable modules from external servers through a communication interface.

The module loader application presents a menu of available compressed executable modules (420). These modules may be located in any of the places mentioned above.

The user selects one of the compressed modules (430). If the module is not stored on the system (440), the module loader obtains a copy of it from an external server (450). Then, proceeding as described earlier, the module loader decompresses and executes the compressed executable module (460). When the compressed, executable module finishes its operations (470), control may return to the module loader. The user can select another compressed module or terminate the module loader application.

A valid BREW module has a relatively simple executable header insofar as is relevant to an embodiment of the invention. For these purposes, the header contains only a version number and a pointer to operating system libraries that the module may call. When the module loader decompresses a compressed BREW executable module, it sets these values, then transfers control to the reconstituted image in the same manner that the system normally would, by calling the BREW entry point function (typically named “AEEMod_Load”) and then calling the “CreateInstance” function to cause the system to begin running the uncompressed code. The “CreateInstance” function requires a BREW identifier (sometimes called a “BREWID”). In this embodiment, the OS may be unaware that a compressed module is executing, subordinate to the module loader. The reconstituted module may also be unaware that it was not started directly by the OS.

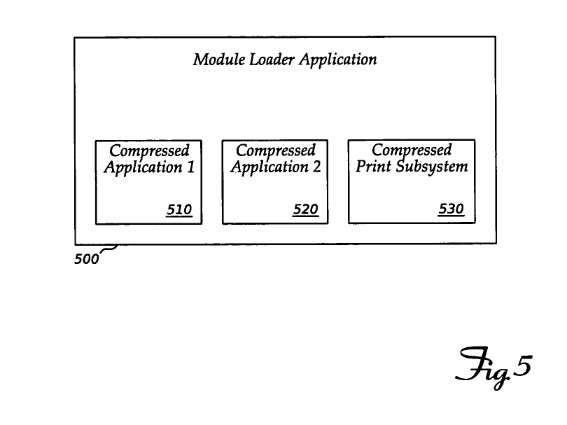

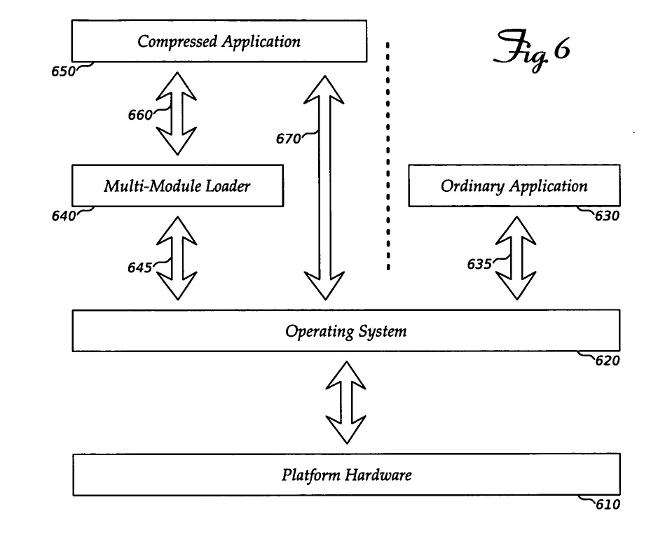

An embodiment of the invention may be a software development tool to prepare compressed executable modules from ordinary BREW applications. These applications may be compressed and stored individually on the system (or on a server accessible from the system), or the compressed applications may be aggregated into a monolithic data object with the module loader. FIG. 5 shows this arrangement: element 500 is the module loader application, which contains within itself two data objects, 510 and 520, each of which is an array of compressed data that can be decompressed to produce a valid BREW application. This figure also suggests a variant embodiment of the present invention, wherein an incomplete executable module such as a subroutine or group of subroutines is stored within an application as an array of compressed data. For example, a seldom-used feature of an application may be stored in compressed form to reduce the application's storage requirements. If the feature is invoked, the application can decompress the compressed data into a temporary buffer, invoke the subroutine in the temporary buffer, and discard the buffer after the feature has performed its work. A compressed group of subroutines to implement a feature is shown in FIG. 5 as Print Subsystem 530.

It was mentioned in reference to FIG. 4 that a module loader application may permit the user to select a first compressed module from a menu, execute the module, then select a second compressed module from the menu and execute the second module. This functionality is significantly different from the simpler case where a compressed module contains a “bootloader” that can decompress and execute the module, but cannot avoid returning control to the operating system after the module finishes executing. A module loader as described above has several advantages over a self-decompressing bootloader arrangement. First, if a module can only decompress and execute itself, each compressed module must include a copy of the decompression bootloader code. This may consume more space than a single decompressor function that can decompress and execute several different compressed executables. Second, a module loader that presents a menu of compressed programs may be used to group related programs together. For example, a computer software publisher may wish to present sample or demo versions of several of its programs, but have all the programs accessible from within a module loader menu system that “brands” the programs by making it clear to the user that all the programs were produced by, and may be obtained from, that publisher. (An added benefit of this arrangement is that the publisher can offer a larger number of its programs within an allotment of space than can its competitor, which does not compress programs, or which only compresses them individually.)

FIG. 6 illustrates some of the relationships a multiple-module-capable module loader may address to be particularly effective. As discussed with reference to FIG. 1, platform hardware 610 occupies the lowest layer of functionality of a mobile computing platform. Devices and resources there are controlled and managed by an operating system 620, and ordinary application 630 can interact with the operating system as indicated by arrow 635 to accomplish its tasks.

According to an embodiment of the invention, a multi-module loader 640 may be executed, and interacts with operating system 620 in largely the same manner as an ordinary application (arrow 645). When a compressed application 650 is invoked, it operates at a higher logical level, or under the control of, multi-module loader 640. Compressed application 650 may interact with multi-module loader 640 as if the multi-module loader stood in the place of the operating system (arrow 660). In some embodiments, compressed application 650 may be permitted to interact directly with operating system 620, as shown by arrow 670. However, care should be taken lest compressed application 650 receive inconsistent information if it queries the operating system. For example, according to operating system 620, the current application may be multi-module loader 640, but multi-module loader 640 may report the compressed application's name if queried. Thus, operating system 620 and multi-module loader 640 may provide different answers to the compressed application's request for the name of the “current application.”

Also, it may be desirable to prevent compressed application operations that might disturb or terminate the multi-module loader. Therefore, embodiments will usually take control of certain communication channels between compressed application 650 and operating system 620, so that (for example) compressed application 650 cannot send a “CloseApplication” message to the operating system (which might result in the multi-module loader being terminated).

In addition to these design goals, it may be preferred to limit the differences between the execution environment of a compressed application and an ordinary application as much as possible, so that (ideally) any ordinary application may be compressed and executed under the multi-module loader with few or no changes, and with few or no user-perceivable differences in the application's behavior.

In the BREW programming and execution environment mentioned earlier, some of these design goals can be achieved by the following techniques. In BREW, applications communicate with the operating system through an event interface, which is like a message passing system. Compressed modules can be permitted to send and receive most events directly to/from the operating system, but a few events must be trapped and processed by the multi-module loader. The trapping can be accomplished by linking the application with special initialization (“bootstrap”) instructions that prepare a modified version of a data structure describing the application. This data structure, called a Shell, can observe, filter, and change messages traveling between the application and the operating system, and can also inject arbitrary messages into the conversation.

Messages whose handling may be changed include CloseApplet, CreateInstance, SetTimer and CancelTimer. CloseApplet would normally terminate the running application, which (from the operating system's perspective) is the multi-module loader. This message is handled as a return of control to the multi-module loader; the compressed module has finished. CreateInstance is adjusted to produce a special version of a generic file manager, so that files created, read, written and/or deleted by the compressed application will have names that reflect the identity of the compressed application. (Otherwise, two different compressed applications that used a file named, for example, “save.dat” might overwrite each other's data.) SetTimer and CancelTimer are normally used by an application to request an update from the operating system. However, it is important for the multi-module loader to be involved in the update procedure to avoid synchronization difficulties.

Embodiments of the invention can apply the modified initialization procedure independently of the compression of an application, so an ordinary (i.e. uncompressed) application may be executed under control of the multi-module loader simply by linking it with the special bootstrap instructions.

An embodiment of the invention may be a machine-readable medium having stored thereon instructions which cause a processor to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), including but not limited to Compact Disc Read-Only Memory (CD-ROMs), Read-Only Memory (ROMs), Random Access Memory (RAM), Erasable Programmable Read-Only Memory (EPROM), and a transmission over the Internet.

The applications of the present invention have been described largely by reference to specific examples and in terms of particular allocations of functionality to certain hardware and/or software components. However, those of skill in the art will recognize that resource conservation via compressing executable modules can also be produced by software and hardware that distribute the functions of embodiments of this invention differently than herein described. Such variations and implementations are understood to be captured according to the following claims.

We claim:

1. A method comprising:
preparing a plurality of modules including executable codes and data bytes;
compressing at least one of the plurality of modules; and
storing the plurality of modules and a module loader on a mobile execution platform; wherein
the module loader is to reference one of the plurality of modules;
decompress the one of the plurality of modules if it was compressed;
copy the one of the plurality of modules into a volatile memory; and
cause a programmable processor to begin executing executable codes in the one of the plurality of modules.

2. The method of claim 1, further comprising:
compressing each of the plurality of modules;
comparing a size of a compressed module with a size of an original module; and
storing a smaller of the compressed module and the original module on the mobile execution platform, the smaller of the two to bear an indicator showing whether it was compressed.

3. The method of claim 1, further comprising:
preparing a monolithic data object containing the module loader and the plurality of modules, wherein
storing the plurality of modules and the module loader on the mobile execution platform includes storing the monolithic data object on the mobile execution platform.

4. The method of claim 1 wherein storing the plurality of modules and the module loader on the mobile execution platform comprises:
transmitting one of the plurality of modules to the mobile execution platform over a wireless connection.

5. The method of claim 1 wherein the executable codes and data bytes are formatted as a Binary Runtime Executable for Wireless (“BREW”) application.

6. The method of claim 1 wherein the compressed one of the plurality of modules is an invalid Binary Runtime Executable for Wireless (“BREW”) application.

7. The method of claim 1 wherein decompressing the one of the modules if it was compressed produces an array of data bytes that is a valid Binary Runtime Executable for Wireless (“BREW”) application.

8. A method comprising:
compressing an original array of data bytes to produce a shorter array of data bytes;
storing the shorter array of data bytes in a nonvolatile memory of a mobile execution platform;
decompressing the shorter array of data bytes to recover the original array of data bytes, the original array to be stored in a second memory of the mobile execution platform; and
executing the original array of data bytes in the second memory.

9. The method of claim 8, further comprising:
transmitting the shorter array of data bytes to the mobile execution platform over a wireless data connection.

10. The method of claim 8 wherein the original array of data bytes contains instructions to implement a function of an application; the method further comprising:
invoking the function of the application; and
discarding the original array stored in the second memory.

11. The method of claim 8, further comprising:
altering the original array of data bytes in the second memory to create a valid executable header.

12. A computer-readable medium containing instructions that, when executed by a system containing a programmable processor, cause the system to perform operations comprising:
displaying a menu containing a plurality of choices;
accepting a selection of one of the plurality of choices;
locating a compressed data object corresponding to the selected one of the plurality of choices;
decompressing the compressed data object into a memory area; and
causing the programmable processor to execute instructions in the memory area.

13. The computer-readable medium of claim 12 wherein the instructions are formatted as a Binary Environment for Wireless (“BREW”) application.

14. The computer-readable medium of claim 12 wherein a structure of the compressed data object is an invalid executable module.

15. The computer-readable medium of claim 12 wherein locating comprises:
retrieving the compressed data object from a remote server over a wireless connection.

16. The computer-readable medium of claim 12 containing additional instructions to cause the system to perform operations comprising:
trapping a “close” event that is to terminate execution of the compressed data object; and returning control to the displaying, accepting, locating, decompressing and causing operations.

17. The computer-readable medium of claim 12 containing additional instructions to cause the system to perform operations comprising:
trapping a “create instance” event that is to create a file interaction object; and
returning a special file interaction object that is to alter a name of a file to reflect an identity of the compressed data object.
